(19) United States
(12) Patent Application Publication
(10) Pub. No.: US 2025/0242258 A1
(43) Pub. Date: Jul. 31, 2025

(54) ONE OR MORE NON-TRANSITORY COMPUTER-READABLE MEDIA, INFORMATION PROCESSING SYSTEM, INFORMATION PROCESSING APPARATUS, AND INFORMATION PROCESSING METHOD

(71) Applicant: NINTENDO CO., LTD., Kyoto (JP)

(72) Inventor: Yusuke KITAZONO, Kyoto (JP)

(21) Appl. No.: 19/005,959

(22) Filed: Dec. 30, 2024

(30) Foreign Application Priority Data
Jan. 30, 2024 (JP) 2024-011595

(51) Int. Cl. A63F 13/58

(52) U.S. Cl. CPC A63F 13/58

(57) ABSTRACT

If a destruction action of a player character hits a virtual object, an example of an information processing system updates a damage value of a voxel in a destruction range, and if the damage value reaches a limit value, the information processing system destroys the virtual object in the destruction range. If the destruction action of the player character hits the virtual object, and if a voxel satisfying a predetermined criterion regarding the damage value is present, the information processing system updates the density of a voxel included in the destruction range, thereby destroying the virtual object in the destruction range.

### CROSS REFERENCE TO RELATED APPLICATION

This application claims priority to Japanese Patent Application No. 2024-011595 filed on Jan. 30, 2024, the entire contents of which are incorporated herein by reference.

### FIELD

The present disclosure relates to a non-transitory computer-readable storage medium having stored therein a game program, an information processing system, an information processing apparatus, and an information processing method that are capable of generating an image using voxels.

### BACKGROUND AND SUMMARY

In the prior art, there is a game where character voxels are created based on image capturing information, and polygon mesh information is generated.

In the above prior art, however, voxels are used to generate an object based on the image capturing information, and the object is not freely deformed using voxel data.

Therefore, an exemplary embodiment discloses a non-transitory computer-readable storage medium having stored therein a game program, an information processing system, an information processing apparatus, and an information processing method that are capable of, in a case where an object is destroyed through a plurality of instructions given by a player in a game where an object can be freely destroyed using a voxel, preventing the shape of the object after the destruction from being awkward.

The exemplary embodiment employs the following configurations.

One or more non-transitory computer-readable media according to the exemplary embodiment are one or more non-transitory computer-readable media having stored therein instructions that, when executed, cause one or more processors of an information processing apparatus to execute image processing. The image processing includes storing, in a memory, volume data indicating a virtual object in a virtual space, and with respect to each voxel included in a voxel space placed in the virtual space, holding voxel values at least including a density indicating a degree to which an object occupies inside of a space defined by the voxel, and a damage value indicating damage caused on the voxel. The image processing further includes, based on an operation input of a player, moving a player character in the virtual space; based on an operation input of the player, causing the player character to perform a destruction action; in a case where the destruction action hits the virtual object, if a voxel satisfying a predetermined criterion is present at least regarding the damage value, updating the voxel values of a voxel included in an erasure range set based on a position of the player character to a density indicating that the virtual object is not present, and if a voxel satisfying the predetermined criterion is not present, updating the voxel values of the voxel included in the erasure range to a damage value indicating that damage increases. Then, the image processing further includes, based on the volume data, at least drawing a polygon mesh representing a surface of the virtual object, thereby generating an image of the virtual space.

Based on the above, in a case where a destruction action hits a virtual object, and if a voxel satisfying a predetermined criterion regarding a damage value is present, it is possible to update voxel values of a voxel included in an erasure range to a density indicating that the virtual object is not present. Consequently, in a case where a voxel satisfying the predetermined criterion is present regarding the damage value, and even if a voxel that does not satisfy the predetermined criterion is present, it is possible to erase a voxel object in the erasure range and prevent the voxel object after the destruction action from having an awkward shape.

Further, the voxel satisfying the predetermined criterion may be a voxel in which the damage exceeds a damage upper limit set in advance in a case where the damage is increased by the destruction action.

Based on the above, if damage increases by the current destruction action and exceeds a damage upper limit, it is possible to erase the voxel object in the erasure range. Thus, before damage is actually caused on a voxel, it is possible to determine whether or not to erase the voxel object in the erasure range.

Further, the image processing further includes, if the destruction action is performed, determining a hit position where the destruction action hits the virtual object. The voxel satisfying the predetermined criterion may be a voxel that is included in a predetermined range including the hit position and has a predetermined damage value.

Based on the above, it is possible to determine a hit position where the destruction action hits the virtual object, and based on the damage value of a voxel in a predetermined range including the hit position, determine whether or not a voxel satisfying the predetermined criterion is present. Consequently, for example, it is possible to reduce the processing load. Further, the image processing may further include making a contact determination between the polygon mesh or a determination polygon mesh representing the surface of the virtual object generated for a determination and a determination shape set based on the destruction action, thereby determining the hit position.

Based on the above, it is possible to make a contact determination with a polygon mesh or a determination polygon mesh using a determination shape based on the destruction action.

Further, the voxel values may further include data indicating hardness or a kind of material of the voxel. The image processing may further include, in a case where the destruction action hits the virtual object, and if the voxel satisfying the predetermined criterion is present, updating the voxel value of a voxel having hardness less than or equal to predetermined hardness or a predetermined kind of material to a density indicating that the virtual object is not present.

Based on the above, in a case where a voxel satisfying the predetermined criterion is present, it is possible to destroy a voxel having hardness less than or equal to predetermined hardness or a predetermined kind of material among voxels included in the erasure range. Consequently, it is possible to destroy the virtual object taking into account the hardness or the kind of material of a voxel.

Further, the erasure range may be a sphere, an ellipsoid, or a shape obtained by asymmetrically deforming an ellipsoid.

Based on the above, the erasure range can be a sphere, an ellipsoid, or a shape obtained by asymmetrically deforming an ellipsoid, and the shape of the virtual object after the destruction can be a natural shape.

Further, the virtual object may be a terrain in the virtual space.

Based on the above, it is possible to destroy a terrain object.

Further, the image processing may further include, based on the density, generating the polygon mesh by an algorithm for placing a polygon so that vertex positions are determined between a voxel defined as being inside the virtual object and a voxel defined as being outside the virtual object, and if the destruction action is performed, recalculating vertices of the polygon mesh in a range including a voxel of which at least the voxel values are updated.

Based on the above, a polygon mesh representing the virtual object is generated, and in a case where the destruction action is performed, vertices of the polygon mesh are recalculated, whereby it is possible to represent the virtual object after the destruction action.

Another exemplary embodiment may be an information processing system that executes the above game program, or may be an information processing apparatus, or may be an information processing method.

According to the exemplary embodiment, in a case where a destruction action hits a virtual object, and if a voxel satisfying a predetermined criterion is present regarding a damage value, it is possible to erase a voxel object in an erasure range and prevent the voxel object after the destruction action from having an awkward shape.

These and other features, aspects and advantages of the subject matter described herein will become more apparent from the following detailed description of the exemplary embodiments when taken in conjunction with the accompanying drawings.

### BRIEF DESCRIPTION OF THE DRAWINGS

FIG. 1 is an illustrative non-limiting diagram showing an example of the state where a left controller 3 and a right controller 4 are attached to a main body apparatus 2;

FIG. 2 is an illustrative non-limiting diagram showing an example of the state where each of the left controller 3 and the right controller 4 is detached from the main body apparatus 2;

FIG. 3 is illustrative non-limiting six orthogonal views showing an example of the main body apparatus 2;

FIG. 4 is illustrative non-limiting six orthogonal views showing an example of the left controller 3;

FIG. 5 is illustrative non-limiting six orthogonal views showing an example of the right controller 4;

FIG. 6 is an illustrative non-limiting block diagram showing an example of the internal configuration of the main body apparatus 2;

FIG. 7 is an illustrative non-limiting block diagram showing an example of the internal configurations of the main body apparatus 2, the left controller 3, and the right controller 4;

FIG. 8 is an example non-limiting diagram showing an example of a terrain object as a voxel object;

FIG. 9 is an example non-limiting diagram showing examples of the states before and after a part of the terrain object shown in FIG. 8 is deleted;

FIG. 10 is an example non-limiting diagram showing examples of the states before and after a part of the terrain object shown in FIG. 8 is deleted;

FIG. 11 is an example non-limiting diagram showing an example of the content of voxel data;

FIG. 12 is an example non-limiting diagram showing an example of property information indicating the property of a material;

FIG. 13 is an example non-limiting diagram showing an example of texture information indicating the texture of a material;

FIG. 14 is an example non-limiting diagram showing an example of a method for generating a mesh;

FIG. 15 is an example non-limiting diagram showing an example of a game image including a terrain object;

FIG. 16 is an example non-limiting diagram of a game space in a game according to the exemplary embodiment viewed from a virtual camera, and an image displayed on a display device;

FIG. 17 is an example non-limiting diagram showing the state where damage is caused on a terrain object 220 by the first punch of a player character PC hits the terrain object 220;

FIG. 18 is an example non-limiting diagram showing the state where damage is caused on the terrain object 220 by the second punch of the player character PC hits the terrain object 220;

FIG. 19 is an example non-limiting diagram showing the state of damage to the terrain object 220 in a case where the third punch of the player character PC hits the terrain object 220;

FIG. 20 is an example non-limiting diagram showing the state after the terrain object 220 is destroyed by the third punch of the player character PC hitting the terrain object 220;

FIG. 21 is an example non-limiting diagram showing the flow of a process regarding the destruction of a voxel;

FIG. 22 is an example non-limiting diagram showing an example of, when a voxel satisfying a predetermined criterion regarding a damage value is present in a case where a destruction action is performed on a voxel object composed of a plurality of materials different in hardness, an update of the density of the voxel;

FIG. 23 is an example non-limiting diagram showing examples of various pieces of data used in information processing by a game system 1;

FIG. 24 is an example non-limiting flow chart showing an example of the flow of game processing executed by the game system 1;

FIG. 25 is an example non-limiting flow chart showing an example of a destruction determination process in step S5; and

FIG. 26 is an example non-limiting flow chart showing an example of a voxel data update process in step S7.

### DETAILED DESCRIPTION OF NON-LIMITING EXAMPLE EMBODIMENTS

### [1. Configuration of Game System]

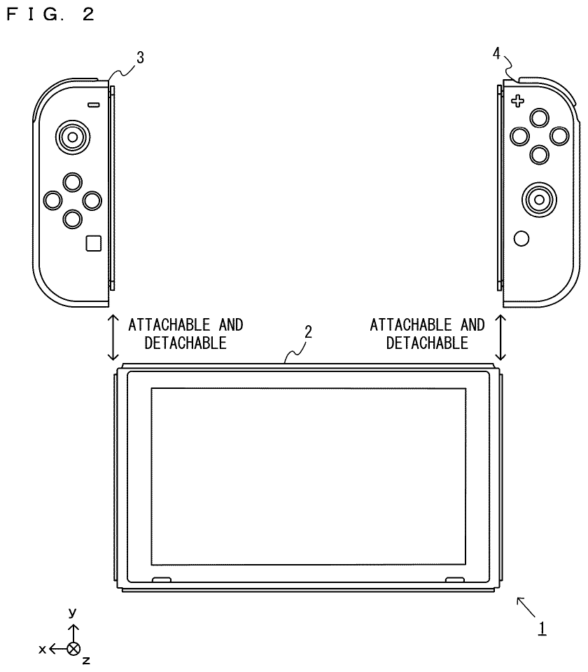

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment is described, and then, the control of the game system 1 according to the exemplary embodiment is described.

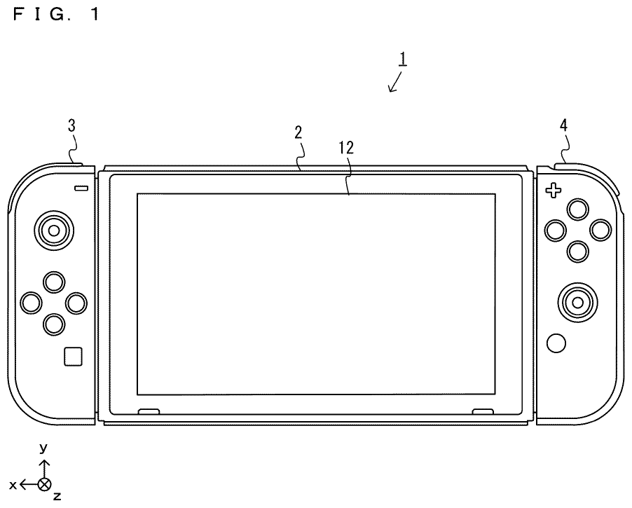

FIG. 1 is a diagram showing an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state where each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

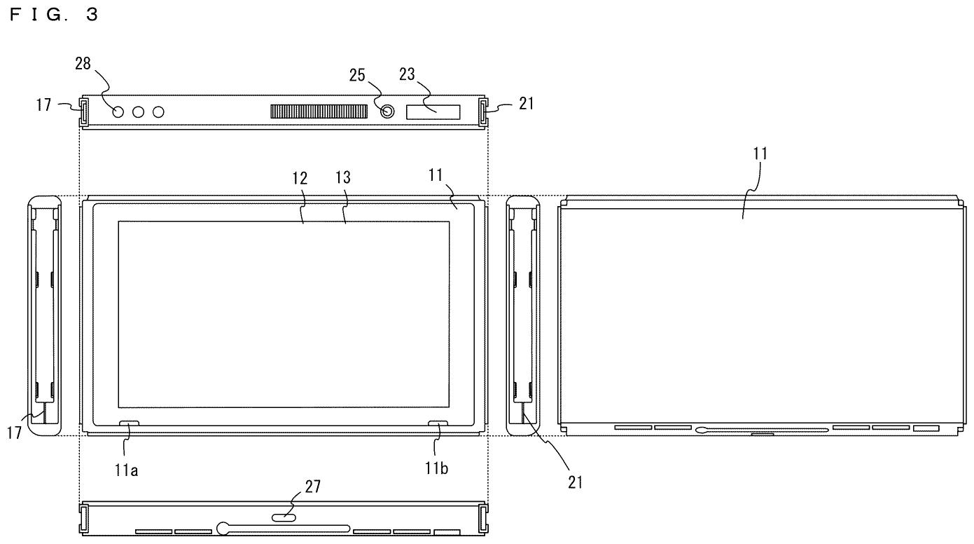

FIG. 3 is six orthogonal views showing an example of the main body apparatus 2. As shown in FIG. 3, the main body apparatus 2 includes an approximately plate-shaped housing 11. In the exemplary embodiment, a main surface (for example, a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

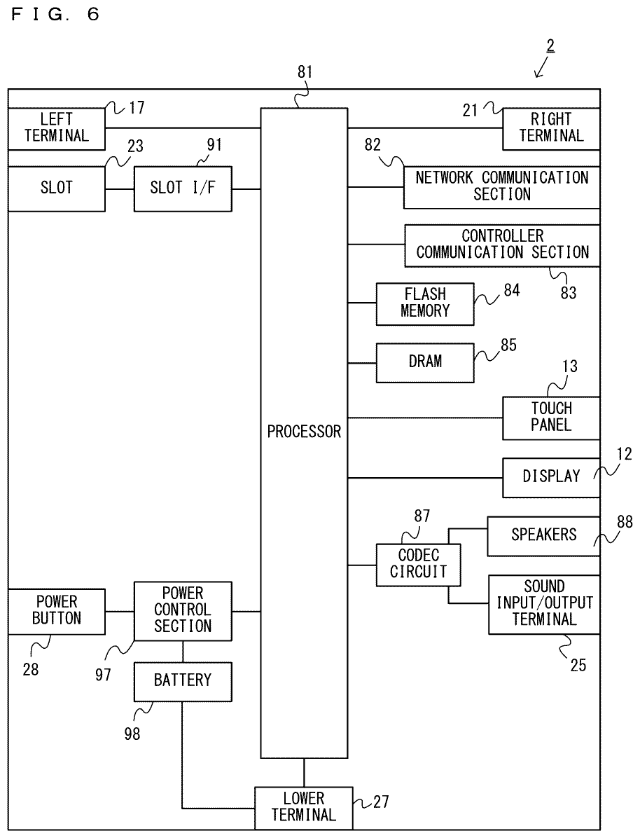

The main body apparatus 2 includes speakers (e.g., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a monitor an image generated by and output from the main body apparatus 2. The monitor may be stationary or may be movable. Further, in the exemplary embodiment, the cradle has the function of charging the unified apparatus or the main body apparatus 2 alone mounted on the cradle. Further, the cradle has the function of a hub device (specifically, a USB hub).

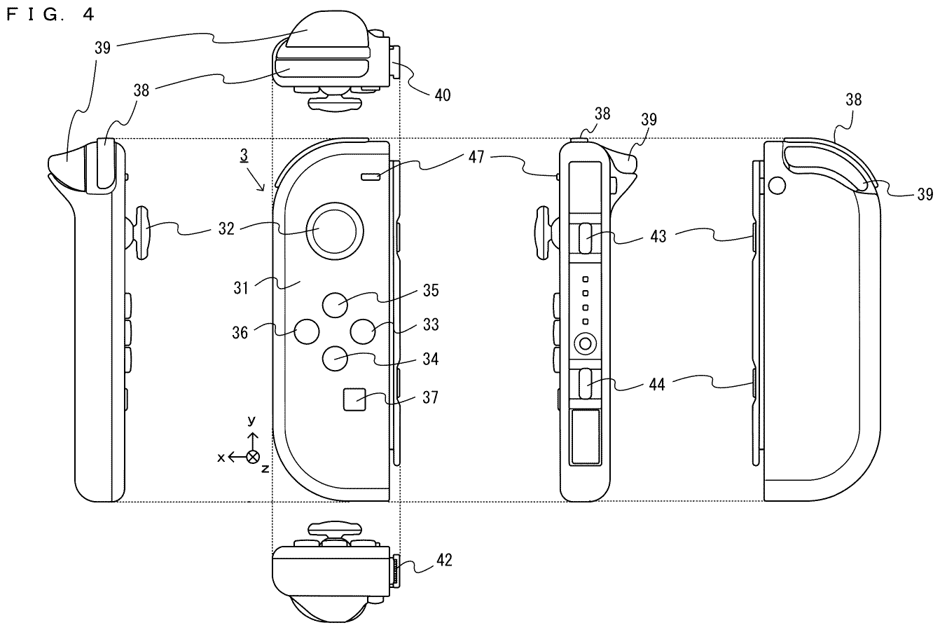

FIG. 4 is six orthogonal views showing an example of the left controller 3. As shown in FIG. 4, the left controller 3 includes a housing 31. In the exemplary embodiment, the housing 31 has a vertically long shape. The housing 31 may be shaped to be long in an up-down direction. For example, along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

Further, the left controller 3 includes a terminal 42 for the left controller 3 to perform wired communication with the main body apparatus 2.

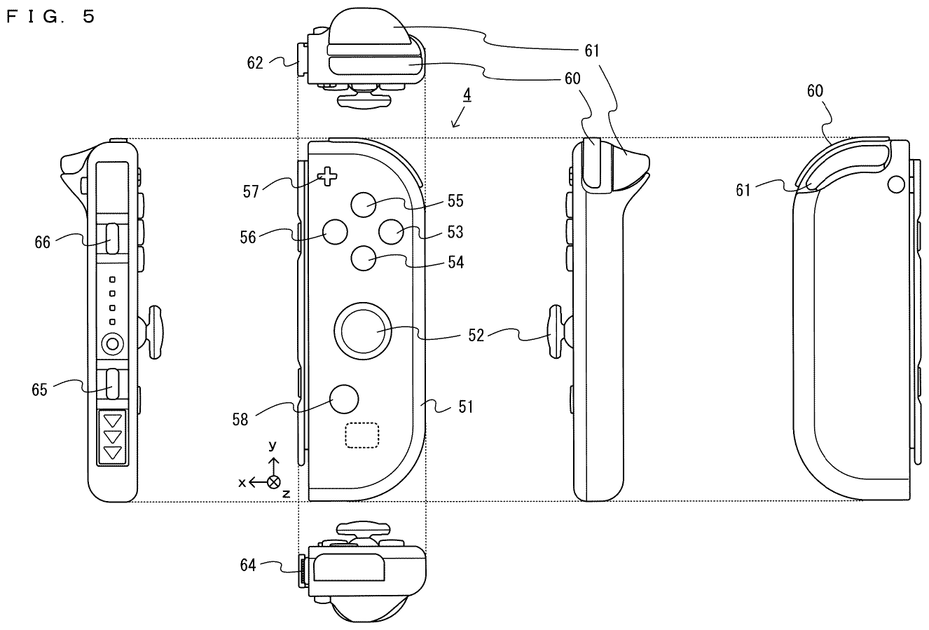

FIG. 5 is six orthogonal views showing an example of the right controller 4. As shown in FIG. 5, the right controller 4 includes a housing 51. In the exemplary embodiment, the housing 51 has a vertically long shape. For example, it may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 91, 97, and 98 shown in FIG. 6 in addition to the components shown in FIG. 3. Some of the components 81 to 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage. For example, in an internal non-transitory storage medium such as a flash memory 84, an external storage non-transitory medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. DRAM 85 and flash memory 84 are illustrative non-limiting examples of non-transitory computer-readable media.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

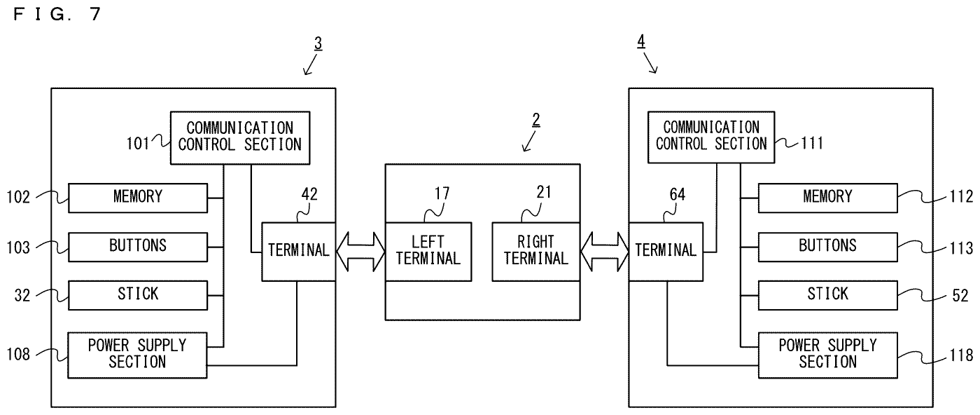

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### [2. Outline of Process on Game System]

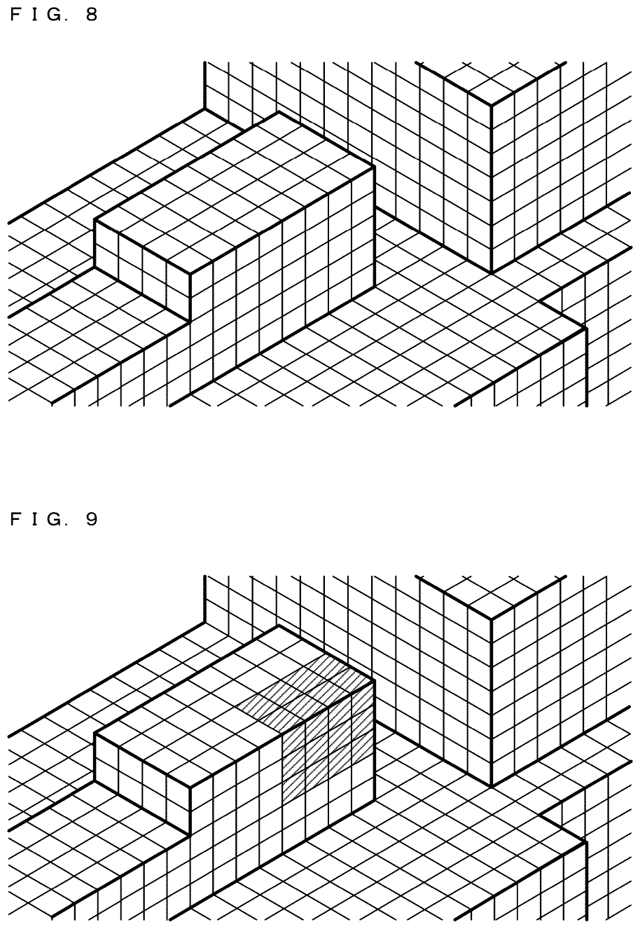

Next, referring to FIG. 8 to FIG. 15, an outline of the process performed on the game system 1 will be described. In the present embodiment, the game system 1 generates a game image in which terrain objects and characters (e.g., the player character controlled by the player) are arranged in a game space, which is a three-dimensional virtual space, and displays the game image on a display device. Note that in the present embodiment, the display device on which the game image is displayed may be the display 12 described above, or may be a monitor.

### [2-1. Voxel]

In the present embodiment, for some objects in the game space, the shape is defined by voxel data. Here, voxels are rectangular parallelepiped (more specifically, cubic) regions arranged in a grid pattern in the game space, and voxel data is data that is set for each voxel. Hereinafter, an object whose shape is defined by voxel data will be referred to as a “voxel object”. In the present embodiment, for each of a plurality of voxels that are set in the game space, the game system 1 stores voxel data as data for generating voxel objects in the game space.

FIG. 8 is a view showing an example of a terrain object, which is a voxel object. As shown in FIG. 8, in the present embodiment, a terrain object representing a terrain such as a ground surface has its shape defined by voxel data. The cubes shown in FIG. 8 represent a terrain object. Note that in FIG. 8, edges of the terrain object are indicated by thick lines. However, these thick lines are added for the purpose of making the drawings easier to understand, and in practice, there is no need for edges of the terrain object to be drawn thick.

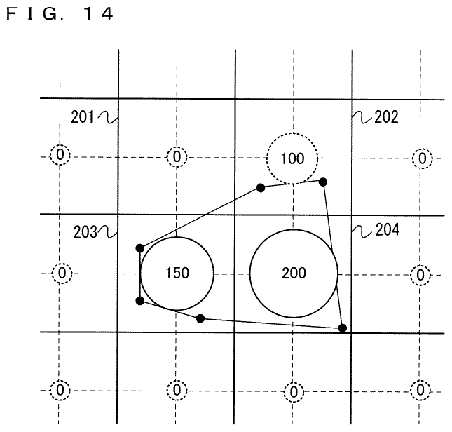

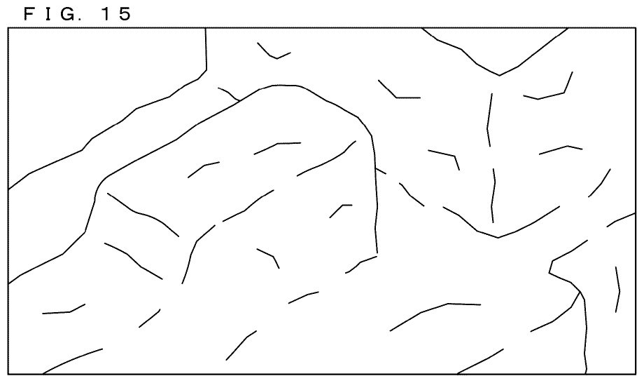

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. The terrain object in FIG. 8 is shown for the purpose of illustrating the relationship between voxels and voxel objects in an easy-to-understand manner. In the present embodiment, in practice, a voxel object is generated by such a rule that results in a terrain object having a complicated shape in comparison with the cubic voxels (e.g., based on the voxel data), such as a terrain object shown in FIG. 14 to be described below, for example. Note that there is no limitation on the rule for determining the shape of the voxel object based on the voxel data. In other embodiments, the game system 1 may generate a voxel object as shown in FIG. 8 based on the voxel data or may generate a voxel object as shown in FIG. 15 based on the voxel data.

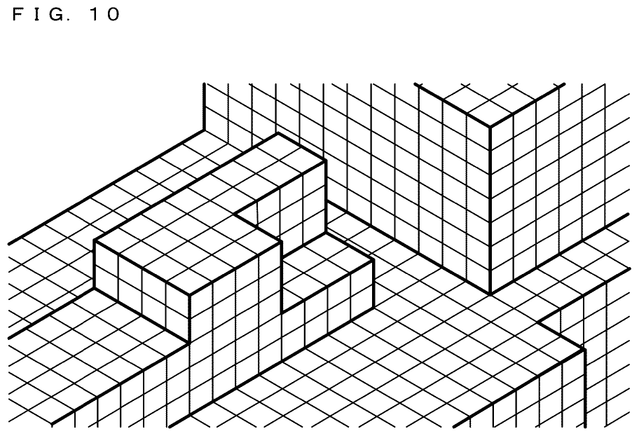

It is possible to change the shape of a voxel object by changing voxel data of voxels. FIG. 9 and FIG. 10 are views showing before and after the deletion of a portion of the terrain object shown in FIG. 8. That is, when the hatched portion of the terrain object shown in FIG. 9 is destroyed, the terrain object changes to a shape as shown in FIG. 10. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, in a case where the shape of a terrain object may be changed as a result of the terrain object in a game being broken for some reason (e.g., the player object striking the terrain object), the game system 1 can freely change the shape of the terrain object by changing the voxel data used to generate the terrain object, rather than directly changing data representing the outer shape of the terrain object (e.g., the mesh to be described below).

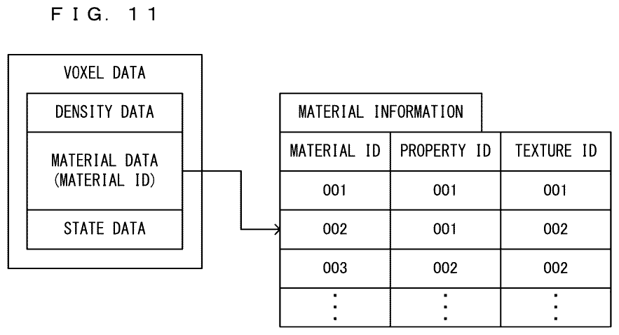

FIG. 11 is a diagram showing an example of content of voxel data. Here, in the present embodiment, the game space can be divided into a plurality of voxels arranged in a grid pattern. The game system 1 stores voxel data for each voxel in the game space so that the voxel data is associated with the voxel. The voxel data represents, for example, the presence/absence of a voxel object in the voxel corresponding to the voxel data.

As shown in FIG. 11, voxel data includes density data. The density data is data of a density indicating the degree to which an object is included in the region defined by each voxel. As will be described in detail below, the position and the shape of the surface of the voxel object (e.g., the mesh to be described below) are determined based on this density. In other words, in the present embodiment, this density is also data used to generate a mesh that defines the surface of the voxel object.

In the present embodiment, the density can take an integer value in the range from the lower limit value (e.g., 0) to the upper limit value (e.g., 255). In the present embodiment, in the game system 1, when the density value set for the voxel is high, the proportion of the volume to be occupied by the voxel object in the voxel is high. When the density value is low, the proportion is low. For example, if the density is 0, there is no object in the voxel, if the density is 255, the inside of the voxel is entirely the object, and if the density is between 0 and 255, the inside of the voxel is occupied by the object to the proportion that is determined based on the density value. Then, the shape of the voxel mesh, e.g., the shape of the voxel object, is determined based on the density. Note however that the shape of the voxel object generated based on the density does not need to have a volume that exactly matches the proportion represented by the density. For example, there is a case where the method of generating a voxel object as shown in FIG. 8 and the method of generating a voxel object as shown in FIG. 15 differ in volume, even if they are based on the same density.

In other embodiments, the density may indicate either a state in which the voxel object occupies the entirety of the region within the voxel or a state in which no voxel object is included in the region within the voxel. For example, the density data may be data that can take only either 0 or 1.

As shown in FIG. 11, voxel data includes material data. The material data represents the material (in other words, the substance) of the voxel object generated by the voxel data. Here, in the present embodiment, materials such as sand, rock and soil, for example, are set for voxel objects. That is, in the present embodiment, a plurality of types of materials are provided as materials that can be set for a voxel object, and one of the materials is set for a voxel object.

As shown in FIG. 11, in the present embodiment, the material data represents the identification information of the material (referred to as “material ID”). In the present embodiment, the game system 1 stores material information representing the property and the texture of the material for each material provided in the game. In the present embodiment, the material information represents associations between the material ID, the property of the material and the appearance (specifically, the texture) of the material. Specifically, the material information is information that represents associations between the material ID, identification information of the property of the material (referred to as “property ID”) and identification information of the texture of the material (referred to as “texture ID”) (see FIG. 11).

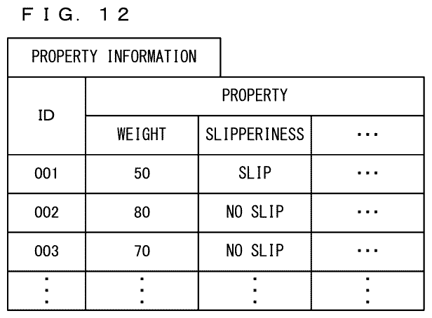

FIG. 12 is a diagram showing an example of property information representing properties of materials. As shown in FIG. 12, the game system 1 stores property information that associates each property ID with information that represents the content of the property represented by the property ID. A property of a material is a property of a voxel object for which the material is set in the game, and it may be information such as weight or slipperiness shown in FIG. 12, for example. Note that the specific content of the property is optional, and for example, the following information may be set as properties of a material.
Temperature
Breakability (e.g., the number of times of impact impartation needed to break a voxel object)
Whether another object can be bonded to a voxel object
Amount of hit points to be regained by the player character when the player character breaks a voxel object
Amount of in-game currency to be gained by the player character when the player character breaks a voxel object

Note that there is no limitation on the specific content of the property to be set for a material. In other embodiments, information different from those listed above may be set as information that represents a property of a material.

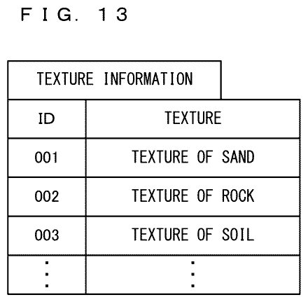

FIG. 13 is a diagram showing an example of texture information representing textures of materials. As shown in FIG. 13, the game system 1 stores texture information that associates the texture ID with the texture represented by the texture ID.

Note that in addition to information of texture, any information regarding the color and/or pattern may be set as data that defines the appearance of a voxel object. For example, a pattern of cracks may be set as information regarding the appearance of a voxel object. By using such a pattern, the game system 1 can generate an image of a voxel object that represents the appearance of cracks.

As described above, in the present embodiment, the material data defines, by the material ID, the property of the voxel object and the texture used for the voxel object. For example, when the material ID represented by the material data included in the voxel data is “002”, the property represented by the property ID “001” that is associated with the material ID in the material information is set as the property of the voxel object corresponding to the voxel data (see arrow shown in FIG. 11). In this case, the texture that is represented by the texture ID “002” associated with the material ID in the material information is applied to the voxel object corresponding to the voxel data (see arrow shown in FIG. 11).

As described above, in the present embodiment, the game system 1 separately manages the property and the texture of the material. Therefore, in the present embodiment, it is possible to easily set a plurality of types of materials having the same property but having different appearances (e.g., different textures) or set a plurality of types of materials having different properties but having the same appearance.

Note that the material data may be any data with which it is possible to identify the property and/or the texture of the material. For example, in other embodiments, the material data may represent the property ID and the texture ID, or may have a data structure that actually includes data representing the property and the texture of the material.

The material data may further represent information related to the material other than the property and the texture described above. For example, the material data may include special effect data that represents the special effect to be triggered upon satisfaction of a special effect triggering condition set for the voxel object (e.g., a portion of the voxel object being broken, or the character stepping on the voxel object). Note that the special effect data may be data that represents a special effect image (e.g., a special effect image showing the voxel object being broken), or may be data that represents a special effect sound (a sound of footstep when the character walks on the voxel object).

As shown in FIG. 11, the voxel data includes state data that represents the state of the voxel object. There is no limitation on the specific content of the state data. For example, the state data may be data that represents whether the voxel object is in a wet state, or may be data that represents the amount of damage applied to the voxel object. The content of the state data may be updated during the game.

### [2-2. Mesh]

In the present embodiment, the surface of the voxel object is represented by a mesh. A mesh is a set of faces (specifically, polygons) placed in the game space. In the present embodiment, the game system 1 generates a mesh for the voxel object based on the voxel data of each voxel set in the game space. An example of how a mesh is generated based on voxel data will now be described.

FIG. 14 is a diagram showing an example method for generating a mesh. Note that in FIG. 14, voxels and meshes are represented in two dimensions for the purpose of making the drawing easier to understand and for the sake of discussion, but in practice, a three-dimensional mesh is generated based on voxels in a three-dimensional space.

As described above, in the present embodiment, the density set for a voxel is in the range of 0 to 255. In the present embodiment, voxels with densities equal to or greater than the reference value are considered to be inside the voxel object, and voxels with densities less than the reference value are considered to be outside the voxel object. It is not necessary to define only voxels with a density of 0 as being outside the voxel object (e.g., reference value=1), and the reference value may be set to 128, for example. In the example shown in FIG. 14, a voxel 201 and the other outer voxels have a density of 0, a voxel 202 has a density of 100, which is less than the reference value (e.g., 128), and voxels 203 and 204 have densities of 150 and 200, which are greater than the reference value. In the present embodiment, the game system 1 generates vertices between those voxels whose densities are equal to or greater than the reference value and those voxels whose densities are less than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is less than the reference value. Then, a polygon mesh is generated by connecting together adjacent vertices if the connection (the boundary between the regions including the vertices) passes through a voxel whose density is equal to or greater than the reference value and a voxel whose density is less than the reference value. The coordinates of each vertex are determined by comparing densities of adjacent voxels and interpolating based on the difference in density for each of the XYZ axes. In this process, the coordinates can be further calculated based on the normal information. The normal information may be stored in advance for at least some of the voxels, or if not stored, the normal information may also be calculated based on densities between adjacent voxels. Note that in FIG. 14, the density of the voxel 202 is less than the reference value, the voxel 202 is treated as being outside the object in the determination of the presence/absence of a vertex, but the density value itself of the voxel 202 is used to calculate the coordinates of the vertices generated. If the reference value were set to a value lower than the density of the voxel 202, it would result in an increase in the vertices on the upper right side and the upper left side in the voxel 202 of FIG. 14.

By generating a polygon mesh as described above, it is possible to generate a shape whose volume is based on (e.g., reflects) the density of each voxel to some extent. Note however that depending on the relationship with neighboring voxels, it is possible that a voxel with a density of 0 may partially include a region inside the object, or a voxel with a density of 255 may partially include a region outside the object. Since voxels with densities less than the reference value are treated as being outside the object in the present embodiment, there are fewer vertices as compared with a case where those voxels are treated as being inside the object, the volume will be smaller accordingly. That is, there is no need to calculate the polygon mesh so that the volume strictly corresponds to the density value.

FIG. 15 shows an example of a game image including a terrain object. In the present embodiment, by generating a mesh as described above, the voxel object can be made in a shape with complicated irregularities compared to the cubic voxels, for example.

Note that there is no limitation on the method of generating a mesh based on voxel data. For example, in other embodiments, if the density of the voxel data is greater than a predetermined value, a mesh may be generated so that a cube is placed in the voxel corresponding to the voxel data (see FIG. 8).

For each face of the mesh generated as described above, the game system 1 determines the appearance (e.g., color and/or pattern) of each such face according to the material identified by the voxel data. Specifically, the game system 1 determines the texture to be used for rendering each face of the mesh based on the voxel data, and maps the determined texture to each face to generate an image of the voxel object. Note that the texture to be mapped to each face of the mesh is determined based on the voxel data of the voxel used to generate the face (which will be referred to as the target voxel) among the voxels where the voxel object exists. Note that the target voxel is, for example, one or more voxels located around the face, although it depends on the mesh generation method. That is, the texture mapped to a face of the mesh is determined to be a texture corresponding to the material set for one or more voxels placed around the face.

Note that in other embodiments, one voxel data may include multiple types (e.g., two types) of material data. In such a case, the voxel data includes ratio data related to the multiple types of material data. The ratio data is data for determining the texture to be used for the voxel object, and represents the ratio by which each of the materials (specifically, the texture corresponding to the material) represented by the multiple types of material data influences the appearance (specifically, the color and/or pattern) of the voxel object. When determining the texture to be mapped to each face of the mesh, the texture is determined based on various data (specifically, density data, multiple types of material data and ratio data) included in the voxel data of the target voxel. For example, when multiple types of materials are set for a target voxel corresponding to one face, a texture corresponding to the (one type of) material with the greatest degree of influence may be used while taking the ratio into consideration, or textures corresponding to multiple types of materials may be used while taking the ratio into consideration.

In other embodiments, there may be both voxel objects for which voxel data including one type of material data is used, and voxel objects for which voxel data including two types of material data is used.

### (Overview of Game Processing)

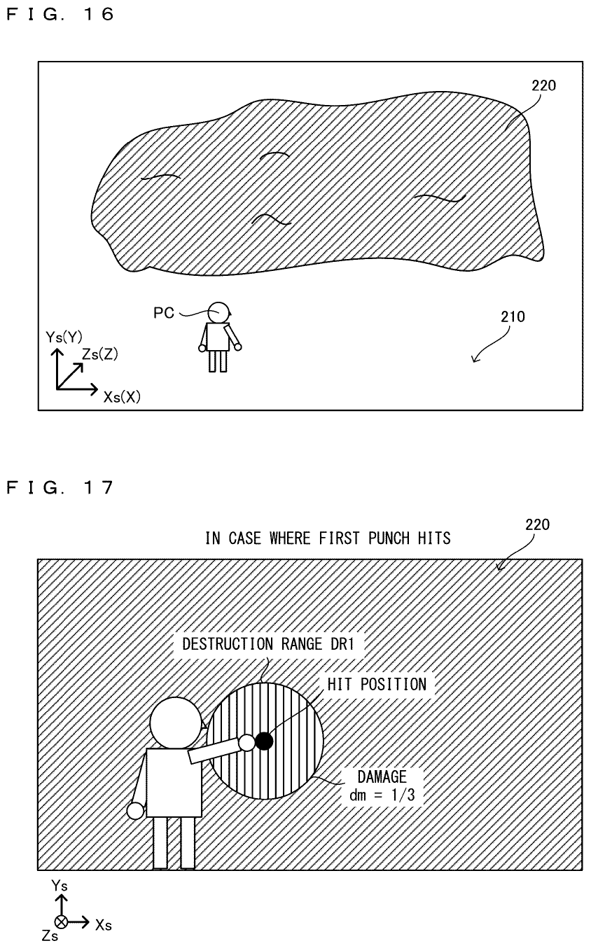

Next, the destruction of a voxel object in a game according to the exemplary embodiment is described. FIG. 16 is a diagram showing an example of an image of a game space viewed from a virtual camera in the game according to the exemplary embodiment, and of a game image displayed on a display device.

As shown in FIG. 16, in the game space, a player character PC is placed. In accordance with an operation of a player (e.g., an operation on the analog stick 32), the player character PC moves in the game space. In accordance with an operation of the player (e.g., an operation on the A-button 53 or the B-button 54), the player character PC performs various actions such as a punch and a jump in the game space. The player character PC is not a voxel object, and is a 3D object the shape of which is defined in advance by polygons.

If the game is started, a fixed voxel space defined by an Xs-Ys-Zs coordinate system is set as a voxel space representing a field in the game space. The axis directions of the Xs-Ys-Zs coordinate system are parallel to those of an XYZ coordinate system of the game space. That is, a Ys axis is an axis directed upward in the game space, and an Xs axis and a Zs axis are axes perpendicular to the Ys axis. Hereinafter, the voxel space defined by the Xs-Ys-Zs coordinate system will occasionally be referred to as a “field voxel space”. The position of each object present in the game space is represented by coordinate values in the Xs-Ys-Zs coordinate system. Although the direction of the Xs-Ys-Zs coordinate system representing the field voxel space match that of the XYZ coordinate system representing the game space here, these directions may not match each other.

In the field voxel space, terrain objects are set as voxel objects. For example, as the terrain objects, a terrain object 210 representing the ground and a terrain object 220 representing a rock pile are set. For example, material data indicating a rock is set in voxel data of each voxel located in a lower portion in the field voxel space, thereby forming the terrain object 210 representing the ground composed of rocks. Material data indicating a rock is set in pieces of voxel data of a plurality of voxels located above the ground in the field voxel space, thereby forming the terrain object 220 representing a rock pile raised from the ground.

In accordance with an instruction from the player, the player character PC can move on a terrain object. In accordance with an instruction from the player, the player character PC can perform a destruction action.

If the destruction action of the player character PC hits a voxel object, there are a case where the voxel object is destroyed and a case where damage is caused on the voxel object, depending on the destruction action. In a case where damage is caused on the voxel object, and if the amount of the damage reaches a limit value, the voxel object is destroyed. If the amount of the damage does not reach the limit value, the voxel object is not destroyed.

Here, for a material set in a voxel, “hardness” is set in advance. That is, the voxel object has hardness relating to the material. For the material, a “limit value” is set in advance. The “limit value” is a value indicating the degree to which the object can endure without being destroyed, and for example, is a value indicating the number of times of the destruction action that the object can endure without being destroyed. The “limit value” may change in accordance with the progress of the game. For example, control may be performed so that even in the case of the same material, the “limit value” of the material is higher in the final phase of the game than in the early phase of the game. Also for the destruction action, “hardness” relating to the type of the destruction action is set in advance. If the player character PC performs the destruction action, the hardness of the destruction action may differ depending on the state of the player character PC at that time. For example, the “hardness” of each of the destruction action and the material of the voxel is set in the range from 1 to 5.

For example, in a case where the destruction action hits the voxel object, and if hardness MH of the material set in the voxel (the hardness of the voxel object) is less than or equal to hardness DH of the destruction action (if DH≥MH is satisfied), damage is not caused on the voxel, and the voxel is destroyed by a single destruction action. Specifically, the density of the voxel is updated. If, on the other hand, the hardness MH of the material set in the voxel is greater than the hardness DH of the destruction action and the difference between the hardness MH and the hardness DH is less than a predetermined value (if 0<MH−DH<the predetermined value is satisfied), the density of the voxel is not updated, and damage is caused on the voxel. Hereinafter, “DH≥MH” will occasionally be referred to as a “first condition”, and “0<MH-DH<the predetermined value” will occasionally be referred to as a “second condition”.

A description is given below of a case where the player character PC punches the terrain object 220 as an example of the destruction action. For example, the hardness MH of the material “rock” of the terrain object 220 is “3”, and the hardness DH of the punch of the player character PC is “2”, and the hardness MH and the hardness DH satisfy the above second condition.

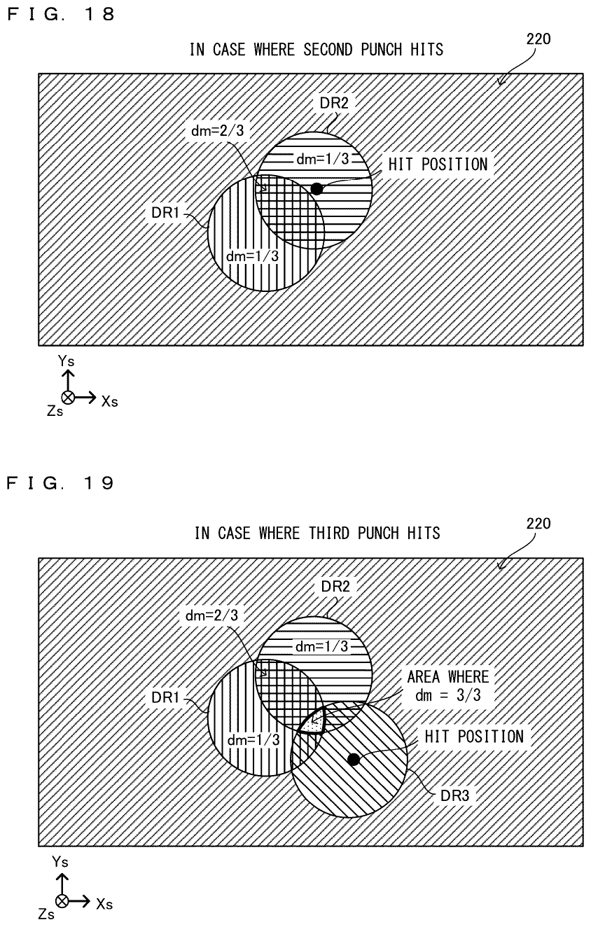

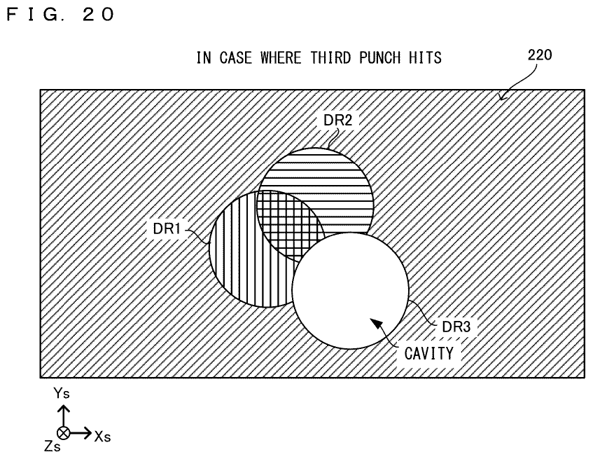

FIG. 17 is a diagram showing the state where damage is caused on the terrain object 220 by the first punch of the player character PC hitting the terrain object 220. FIG. 18 is a diagram showing the state where damage is caused on the terrain object 220 by the second punch of the player character PC hitting the terrain object 220. FIG. 19 is a diagram showing the state of damage caused on the terrain object 220 in a case where the third punch of the player character PC hits the terrain object 220. FIG. 20 is a diagram showing the state after the terrain object 220 is destroyed by the third punch of the player character PC hitting the terrain object 220. FIGS. 17 to 20 show two-dimensional representation of the terrain object 220 as viewed from the front.

As shown in FIG. 17, if the punch of the player character PC hits the terrain object 220, a destruction range DR is set based on a hit position indicating the position hit by the punch, and damage is caused on a voxel included in the destruction range DR. A damage value dm is stored in each voxel. For example, 1 is added to the damage value dm of a voxel included in a destruction range DR1 by the first punch. Every time the destruction action is performed, a value is added to the damage value of the voxel. If the damage value reaches a limit value “3”, the voxel is destroyed. Thus, if the player character PC punches the same place as that in FIG. 17, the voxel in the destruction range DR1 is destroyed in accordance with the third punch. That is, the density of the voxel in the destruction range DR1 is updated to a value indicating that an object is not present.

Here, if the second punch hits a position different from the position hit by the first punch, as shown in FIG. 18, a destruction range DR2 is set in accordance with the position hit by the second punch, and the damage value “1” is added to a voxel included in the destruction range DR2. Since the damage value “1” is already added to the destruction range DR1 by the first punch, the damage value of an overlapping range between the destruction range DR1 and the destruction range DR2 is “2”. The damage value of a voxel in the destruction range DR2 other than this overlapping area is “1”. In this state, the damage values of all the voxels of the terrain object 220 are less than the limit value “3”, and therefore, none of these voxels is destroyed.

Next, the player character PC throws the third punch, and the third punch hits the terrain object 220. As shown in FIG. 19, if the position hit by the third punch is different from the positions hit by the first and second punches, a value is added to the damage value of a voxel in the destruction range DR3 set in accordance with the hit position of the third punch. In this case, the damage value of an overlapping area between the three destruction ranges DR1 to DR3 is “3”, the damage value of an overlapping area between the two destruction ranges DR1 and DR3 is “2”, the damage value of an overlapping area between the two destruction ranges DR2 and DR3 is “2”, and the damage value of a voxel of the destruction range DR3 other than these overlapping areas is “1”. That is, in the destruction range DR3 set in accordance with the third punch, a voxel of which the damage value is “1”, a voxel of which the damage value is “2”, and a voxel of which the damage value is “3” are present. In such a case, in the exemplary embodiment, voxels in the destruction range DR3 including not only a voxel of which the damage value is “3” but also a voxel of which the damage value is “1” and a voxel of which the damage value is “2” are destroyed.

That is, if a voxel of which the damage value is greater than or equal to the limit value “3” is present by the third punch, voxels in the destruction range DR3 including also a voxel that does not reach the limit value are destroyed (erased). Consequently, as shown in FIG. 20, in the destruction range DR3 set in accordance with the third punch, an object ceases to be present, and in the terrain object 220, a cavity having the same shape as or a shape similar to that of the destruction range DR3 occurs. On the other hand, the area DR1 on which damage is caused by the first punch and the area DR2 on which damage is caused by the second punch are not destroyed, and the damage remains accumulated.

In FIG. 19, if only a voxel of which the damage value reaches the limit value “3” is destroyed, the voxel object after the destruction has an awkward shape. Further, there is also a possibility that the range of destruction becomes so narrow that it is difficult to play. Further, there is also a possibility that a position shifted from the hit position hit by the third punch is destroyed, a voxel around the hit position remains, and the player feels discomfort.

Thus, in the exemplary embodiment, when it is assumed that a value is added to a damage value by a current destruction action, and if a voxel of which the damage value is greater than or equal to a limit value is present, voxels in a destruction range set in accordance with the current destruction action are destroyed. Specifically, among all the voxels in the destruction range set in accordance with the current destruction action, a voxel having hardness less than or equal to the hardness of a voxel of which the damage value is greater than or equal to the limit value is destroyed. Consequently, it is possible to prevent the situation where only a position shifted from a hit position hit by a punch is destroyed. Thus, it is possible to prevent a voxel object after destruction from being awkward.

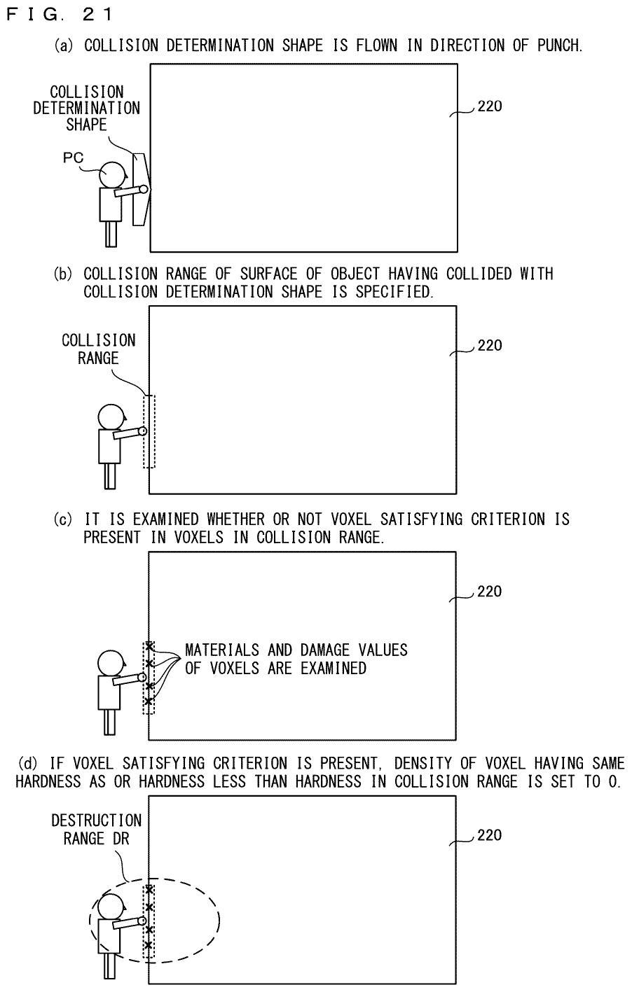

Next, with reference to FIG. 21, a description is given of the flow of a process until a voxel is destroyed. FIG. 21 is a diagram showing the flow of a process regarding the destruction of a voxel.

As shown in FIG. 21(a), if the player character PC throws a punch, a collision determination shape for use in a collision determination with another object is flown. The collision determination shape is a shape internally used by the information processing system for a collision determination, and is not displayed on the game screen. For example, the collision determination shape is a sphere, a column, a disk, a cone, or a pyramid including the position of the first of the player character PC and is flown into the virtual space in accordance with the punch. The collision determination shape is flown, whereby it is determined whether or not the collision determination shape collides with another object (a voxel object or another 3D object). For example, a collision determination between the collision determination shape and a polygon mesh forming the surface of the voxel object is made.

For the voxel object, a determination polygon mesh for determining contact (collision) with another object may be prepared separately from the polygon mesh forming the surface. In this case, a collision determination between the collision determination shape and the determination polygon mesh is made. The collision determination shape may have a different size or a different shape in accordance with the type of the destruction action.

As shown in FIG. 21(b), if the collision determination shape collides with the terrain object 220, the collision range of the collision is identified. Specifically, the range where the collision determination shape and the polygon mesh of the terrain object 220 collide with each other is identified. The collision range identified here is the surface of the terrain object 220.

Next, as shown in FIG. 21(c), regarding voxels in the identified collision range, it is examined whether or not a voxel satisfying a predetermined criterion regarding the damage value is present. The voxel satisfying the predetermined criterion is a voxel on which damage is caused by a punch (e.g., a voxel satisfying the above second condition) and of which the damage value is greater than or equal to the limit value by the current punch. For example, the materials and the damage values of the voxels in the collision range are examined, and a voxel in which the hardness MH of the material of the voxel is greater than the hardness DH of the punch and the difference between the hardness MH and the hardness DH is less than the predetermined value (a voxel satisfying the second condition) is extracted. Then, based on the current damage value of the extracted voxel, it is determined whether or not the damage value is greater than or equal to the limit value if a value is added to the damage value by the current punch.

As shown in FIG. 21(d), if a voxel satisfying the above predetermined criterion is present in the voxels in the collision range, the destruction range DR is set based on the position hit by the punch (the hit position). The hit position may be the center of the collision determination shape, or may be any position in the collision range. The destruction range DR is a range having a predetermined shape including the hit position and includes the above collision range. The destruction range DR is a shape different from the above collision determination shape, and for example, may be a sphere, an ellipsoid, or a shape obtained by asymmetrically deforming an ellipsoid in a predetermined direction. Then, the densities of all the voxels included in the destruction range DR and having hardness less than or equal to the hardness of the voxel satisfying the above predetermined criterion are set to a value indicating that an object is not present. Specifically, the density of a voxel located inside the destruction range DR is set to “0”, and the density of a voxel located at the boundary of the destruction range DR is reduced to, for example, a value less than or equal to a reference value (or greater than or equal to the reference value). Consequently, the voxel object included in the destruction range DR is destroyed (erased).

If, on the other hand, a voxel satisfying the above predetermined criterion is not present in the voxels in the collision range, a voxel satisfying the above second condition included in the destruction range DR is not destroyed (the density of the voxel is not updated), and a value is added to the damage value.

A voxel satisfying the above first condition (a voxel in which the hardness DH of the punch is greater than or equal to the hardness MH of the material) is destroyed. That is, a voxel composed of a material having the same hardness as or softer than the punch is destroyed by the current punch, regardless of the damage value. The density of a voxel that satisfies neither the first condition nor the second condition is not updated, and a value is not added to the damage value of the voxel, either. That is, a value is not added to the damage value of a voxel composed of a material (e.g., iron) sufficiently hard for the hardness of the punch, and the voxel is not destroyed, either.

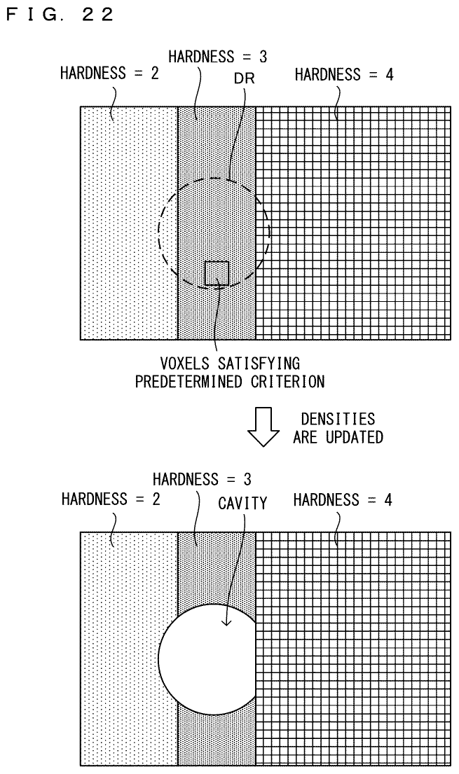

FIG. 22 is a diagram showing an example of, when a voxel satisfying the predetermined criterion regarding the damage value is present in a case where the destruction action is performed on a voxel object composed of a plurality of materials different in hardness, an update of the density of the voxel.

As shown in FIG. 22, for example, a case is assumed where a punch hits a voxel object composed of a material having a hardness of “2”, a material having a hardness of “3”, and a material having a hardness of “4”. If a voxel satisfying the predetermined criterion regarding the damage value is present in the destruction range DR relating to the current punch, among voxels in the destruction range DR, the density of a voxel having a hardness of “3”, which is the same as the hardness of the voxel determined as satisfying the predetermined criterion, namely “3”, is updated as described above, and the voxel is destroyed. Also a voxel having a hardness of “2”, which is smaller than the hardness of the voxel determined as satisfying the predetermined criterion, namely “3”, is also destroyed. On the other hand, regarding a voxel having a hardness of “4”, the difference between the hardness of the voxel, namely “4”, and the hardness of the punch, namely “2”, is greater than or equal to the predetermined value. Thus, the density of the voxel is not updated, and a value is not added to the damage value of the voxel, either. As a result, as shown in the lower diagram of FIG. 22, in the voxel object after the densities are updated, a shape in which a part of the destruction range DR is missing is destroyed, and a cavity having this shape is formed.

As described above, in the exemplary embodiment, for each voxel, voxel values including a density indicating the degree to which an object occupies the inside of a space defined by the voxel, and a damage value indicating damage caused on the voxel are set. If a destruction action hits a voxel object, a value is added to the damage value of a voxel. If the damage value accumulated in the voxel reaches a limit value by the destruction action performed multiple times, the voxel is destroyed. If the destruction action hits the voxel object, and a voxel satisfying a predetermined criterion is present, voxels included in a destruction range set based on the position of the player character PC are erased. If a voxel satisfying the predetermined criterion is not present, values are added to the damage values of the voxels included in the destruction range.

Consequently, in a game where a voxel object is destroyed by a destruction action performed multiple times, it is possible to, if the destruction action hits the voxel object, prevent the shape of the voxel object after destruction from being awkward.

In the exemplary embodiment, if the destruction action is performed, first, a collision determination using a collision determination shape is made, and only in a collision range identified by the collision determination (the surface of the voxel object), it is determined whether or not a voxel satisfying the predetermined criterion is present. Then, if it is determined that a voxel satisfying the predetermined criterion is present, voxels in the destruction range inside the voxel object are erased. Only in a part of the voxel object, it is determined whether or not a voxel satisfying the predetermined criterion is present. Thus, it is possible to reduce the calculation load.

In the game according to the exemplary embodiment, in addition to the above terrain objects 210 and 220, various other voxel objects also exist. For example, in the field voxel space, voxel objects composed of various materials that can be destroyed by the player character PC are placed. For example, a second voxel space different from the field voxel space may be set, and a voxel object (e.g., an enemy object) defined by voxels in the second voxel space may exist. For example, the position or the orientation of the second voxel space changes in the virtual space, whereby the enemy object performs an action in the virtual space. The above process regarding the damage value is also performed on the voxel object defined in the second voxel space.

### [3. Specific Example of Processing by Game System]

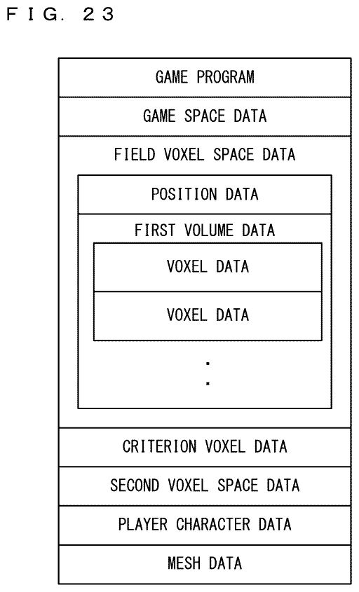

Next, with reference to FIGS. 23 to 26, a specific example of information processing by the game system 1 is described.

FIG. 23 is a diagram showing examples of various pieces of data used in the information processing by the game system 1. As shown in FIG. 23, the game system 1 stores a game program, game space data, field voxel space data, criterion voxel data, second voxel space data, player character data, and mesh data.

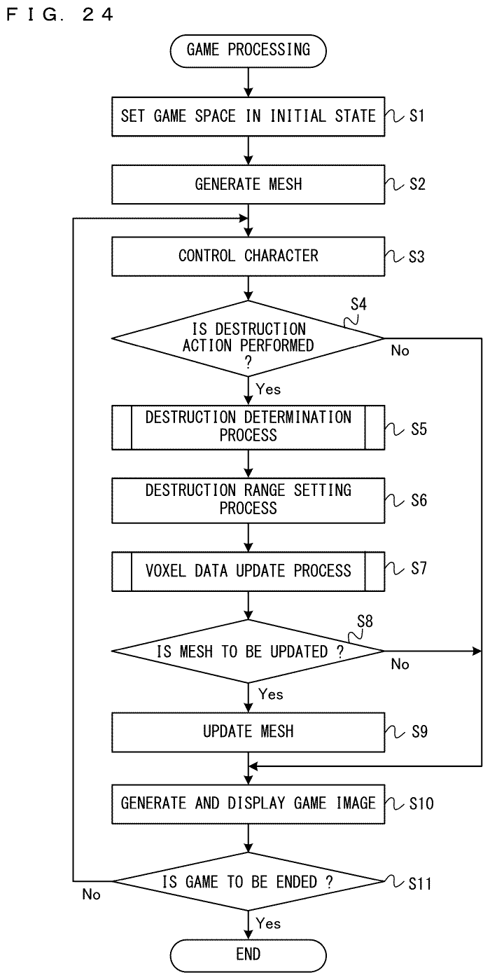

The game program is a program for executing game processing according to the exemplary embodiment (specifically, game processing shown in FIG. 24). The game program is stored in advance in a storage medium attached to the slot 23 or the flash memory 84 and is loaded into the DRAM 85 when the game is executed.

The game space data is data for defining the game space and includes data indicating the above XYZ coordinate system.

The field voxel space data is data regarding the entirety of the field voxel space. As shown in FIG. 23, the field voxel space data includes position data. The position data is data indicating the position and the rotation of the field voxel space in the game space. In the exemplary embodiment, the field voxel space is fixed to the game space.

The field voxel space data also includes first volume data. The first volume data includes voxel data of each voxel in the field voxel space. Each piece of voxel data includes density data, material data, and a damage value. A density and a material are set for each voxel in the first volume data, and a mesh is generated based on the voxel data, whereby a terrain is formed in the game space. In the storage medium attached to the slot 23 or the flash memory 84, the initial first volume data is stored in advance. When the game starts, the first volume data stored in the storage medium attached to the slot 23 or the flash memory 84 is loaded into the DRAM 85. Consequently, initial terrains are formed. For example, as the initial terrains, the terrain object 210 representing a horizontal ground and the terrain object 220 representing a rock pile are formed. Each piece of voxel data included in the first volume data stored in the DRAM 85 is updated during the execution of the game, whereby the terrains are changed.

The criterion voxel data is voxel data of a voxel determined as satisfying the above predetermined criterion regarding the damage value. The criterion voxel data is stored in a case where the destruction action hits a voxel object and if a voxel determined as satisfying the above predetermined criterion is present.

The second voxel space data is data regarding the second voxel space different from the field voxel space placed in the game space. The second voxel space data includes data similar to that of the field voxel space data. The second voxel space data includes second volume data holding a plurality of pieces of voxel data for representing a voxel object (e.g., an enemy object) capable of moving in the virtual space.

The player character data is data regarding the player character PC and includes data indicating the position and the orientation of the player character PC in the game space.

The mesh data is data indicating a mesh set for a voxel object placed in the game space. The mesh data includes, for example, data indicating the position of each vertex in the mesh. The mesh data is generated based on the first volume data, the second volume data, and the like.

The game system 1 stores data of the above property information and texture information, data regarding various characters that appear in the game, and the like as data stored in advance before the execution of the game processing in addition to the data shown in FIG. 23. For example, the game system 1 also stores 3D object data indicating a 3D object different from a voxel object (e.g., the player character PC). The game system 1 also stores voxel space data with respect to each voxel object capable of moving in the game space.

FIG. 24 is a flow chart showing an example of the flow of the game processing executed by the game system 1. The game processing shown in FIG. 24 is started in accordance with, for example, an instruction to start the game given by the player.

In the exemplary embodiment, the description is given on the assumption that the processes of steps shown in FIG. 24 are executed by the processor 81 of the main body apparatus 2 executing the game program stored in the game system 1. In another exemplary embodiment, however, some of the processes of the above steps may be executed by a processor (e.g., a dedicated circuit or the like) different from the processor 81. Further, in a case where the game system 1 can communicate with another information processing apparatus (e.g., a server), some of the processes of the steps shown in FIG. 24 may be executed by the other information processing apparatus. The processes of all of the steps shown in FIG. 24 are merely illustrative. Thus, the processing order of the steps may be changed, or another process may be performed in addition to (or instead of) the processes of all of the steps, so long as similar results are obtained.

The processor 81 executes the processes of steps shown in FIG. 24 using a memory (e.g., the DRAM 85). That is, the processor 81 stores information (in other words, data) obtained in the processing steps in the memory, and if the information is used in the subsequent processing steps, reads the information from the memory and uses the information.

As shown in FIG. 24, in step S1, the processor 81 sets the game space in an initial state. Specifically, the processor 81 acquires the first volume data indicating a terrain in the game space in the initial state from the storage medium attached to the slot 23 and stores a part or the entirety of the acquired first volume data in the DRAM 85. The processor 81 also reads the player character data from the above storage medium, sets the initial position and the orientation of the player character, and stores the initial position and the orientation in the DRAM 85. The processor 81 also sets the initial position and the orientation of the virtual camera and stores the initial position and the orientation in the DRAM 85.

The voxel data to be written to the DRAM 85 may be voxel data of a partial range used to generate a game image in voxel data of the entire range of the game space. The processor 81 may generate an image of an object using, for example, pieces of voxel data of voxels included in a partial range (e.g., a range within a predetermined distance from the position of the virtual camera) of the game space. If voxel data regarding the partial range of the game space is written, a process similar to that of the above step S1 is executed at an appropriate timing during the execution of the series of processes of steps S2 to S11 (e.g., the timing when the position of the virtual camera moves by a predetermined distance or more).

In step S2, the processor 81 generates a mesh regarding each voxel object. The mesh is generated in accordance with the method described in the above “[2-2. Mesh]”. Specifically, based on the first volume data stored in the DRAM 85 in step S1, the processor 81 generates a mesh representing each voxel object. A polygon is generated so that vertex positions are determined between a voxel defined as being inside the voxel object and a voxel defined as being outside the voxel object. Consequently, a polygon mesh representing the voxel object is set in the game space. For example, the terrain objects 210 and 220 are set in the game space. An example of a specific method for determining the vertex positions is as described above with reference to FIG. 14. After step S2, the game is started, and the processes of steps S3 to S11 are repeatedly executed at predetermined frame time intervals (e.g., 1/60-second intervals) during the game.

In step S3, the processor 81 controls the actions of various objects (e.g., the player character PC) that appear in the game space. For example, based on operation data received from the controllers 3 and 4, the processor 81 moves the player character PC and causes the player character PC to perform a predetermined action (the destruction action, a jump, or the like). The destruction action of the player character PC may be a punch, a kick, the throwing of a bullet, or the like. After step S3, the process of step S4 is executed.

In step S4, based on operation data from the controllers, the processor 81 determines whether or not the destruction action is performed by the player character PC. Specifically, based on the operation data from the controllers, it is determined whether or not a predetermined button of the left controller 3 or the right controller 4 is pressed. If the result of the determination in step S4 is affirmative, the process of step S5 is executed. If, on the other hand, the result of the determination in step S4 is negative, the process of step S10 is executed.

In step S5, the processor 81 performs a destruction determination process. Here, first, it is determined whether or not the destruction action of the player character PC hits a voxel object (e.g., a terrain object). If the destruction action hits the voxel object, it is determined whether or not a voxel satisfying the predetermined criterion is present. If it is determined that a voxel satisfying the predetermined criterion is present, a condition flag for destroying a voxel in a destruction range is set to ON. The details of the destruction determination process in step S5 will be described below. Next, the processor 81 executes the process of step S6.

In step S6, the processor 81 performs a destruction range setting process for setting a destruction range in accordance with the voxel object hit by the destruction action. For example, if the destruction action hits a terrain object defined by voxels in the field voxel space, the processor 81 sets a first destruction range including the hit position of the destruction action determined in step S5. For example, if the destruction action hits an object (e.g., an enemy object) defined by voxels in the second voxel space, the processor 81 sets a second destruction range including the hit position determined in step S5. For example, the destruction range is a sphere, an ellipsoid, or a shape obtained by asymmetrically deforming an ellipsoid in the left-right direction or the up-down direction, and may be a different shape from or the same shape as the above collision determination shape. Next, the processor 81 executes the process of step S7.

In step S7, the processor 81 executes a voxel data update process. The details of the voxel data update process in step S7 will be described below. Next, the processor 81 executes the process of step S8.

In step S8, the processor 81 determines whether or not a mesh is to be updated. Here, if voxel data is updated in step S7, the processor 81 determines that a mesh is to be updated. If the result of the determination in step S8 is affirmative, the process of step S9 is executed. If, on the other hand, the result of the determination in step S8 is negative, the process of step S10 is executed. Even if voxel data is updated in step S7, but if an updated voxel is not present in the image capturing range of the virtual camera, the processor 81 may determine in step S8 that a mesh is not to be updated. That is, even if the destruction action hits a voxel object and a part or the entirety of the voxel object is destroyed, but if a voxel object in the game space that can be viewed from the virtual camera is not destroyed, a mesh may not be updated. When the processing load is high, the update of the mesh may not be performed in this frame, and may be carried over to the next frame and subsequent frames.

In step S9, the processor 81 updates a mesh regarding a voxel object of which voxel data is changed in step S7. Specifically, based on the updated voxel data, the vertex positions of the mesh are recalculated. The updated mesh is stored as mesh data in the DRAM 85. That is, based on the voxel data updated in step S7, the processor 81 generates the mesh of the destroyed voxel object. Consequently, during the game, it is possible to dynamically change the mesh of a voxel object on which the destruction action is performed. In step S9, the vertices of the mesh of only a portion where the voxel data is updated are recalculated. Regarding the mesh of a portion where the voxel data is not updated, the vertex positions of the mesh generated in step S2 are used. As described above, the mesh is recalculated only regarding the updated voxel data, and therefore, it is possible to decrease the processing load. In another exemplary embodiment, in step S9, based on all the pieces of voxel data in the game space (or all the pieces of voxel data in the image capturing range of the virtual camera) including both voxel data that is updated and voxel data that is not updated, the vertex positions of the mesh may be recalculated. After step S9, the process of step S10 is executed.

In step S10, the processor 81 generates a game image representing the game space based on the virtual camera and displays the generated game image on the display device. Specifically, the processor 81 generates a game image of the mesh generated in step S2 or S9 when viewed from the position of the virtual camera. Consequently, a game image representing the game space including a voxel object and another 3D object (e.g., the player character PC) is generated. Then, the processor 81 displays the generated game image on the display device. After step S10, the process of step S11 is executed.

In step S11, the processor 81 determines whether or not the game is to be ended. For example, the processor 81 determines whether or not an instruction to end the game is given by the user. If the result of the determination in step S11 is negative, the process of step S3 is executed again. From this point onward, the series of processes of steps S3 to S11 are repeatedly executed until it is determined in step S11 that the game is to be ended. If, on the other hand, the result of the determination in step S11 is affirmative, the processor 81 ends the game processing shown in FIG. 24.

### (Destruction Determination Process)

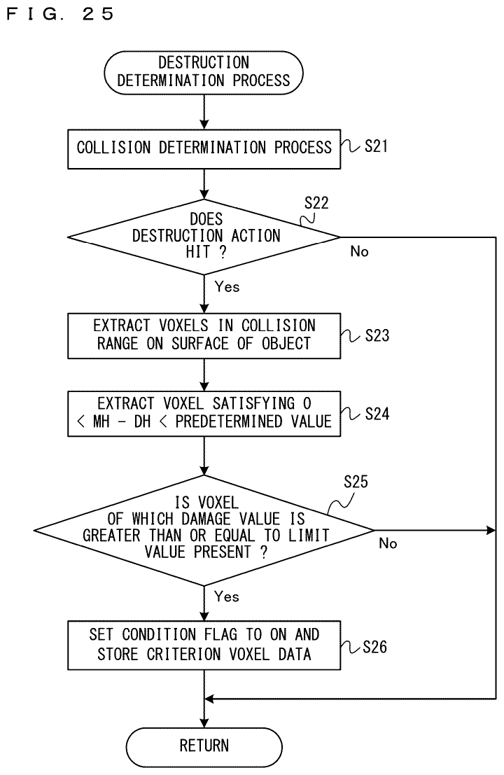

With reference to FIG. 25, the destruction determination process in step S5 is described below. FIG. 25 is a flow chart showing an example of the destruction determination process in step S5.

In step S21, the processor 81 performs a collision determination process. Specifically, the processor 81 flies the collision determination shape from the position (e.g., near the first) of the player character PC in the direction in which the destruction action is performed, thereby making a collision determination with another object (see FIG. 21(a)). For example, it may be determined whether or not the collision determination shape and the polygon mesh forming the surface of the voxel object collide with each other. Alternatively, a determination polygon mesh for determining the contact of the voxel object may be prepared, and a collision determination between the collision determination shape and the determination polygon mesh may be made. Next, the process of step S22 is performed.

In step S22, the processor 81 determines whether or not the destruction action hits the voxel object as a result of the collision determination process. If the result of the determination in step S22 is affirmative, next, the process of step S23 is executed. If, on the other hand, the result of the determination in step S22 is negative, the process in FIG. 25 ends.

In step S23, the processor 81 identifies a collision range on the surface of the voxel object having collided with the collision determination shape and extracts voxels in the collision range (see FIG. 21(b)). Next, the process of step S24 is performed.

In step S24, the processor 81 extracts a voxel satisfying 0<MH-DH<the predetermined value among the voxels in the collision range. That is, here, a voxel in which the hardness MH of the material set for the voxel is greater than the hardness DH of the destruction action and the difference between the hardness MH and the hardness DH is less than the predetermined value is extracted. This voxel is a voxel which satisfies the above second condition and on which damage can be caused by the current destruction action. Next, the process of step S25 is performed.

In step S25, the processor 81 determines whether or not, if a value is added to the damage value by the current destruction action, a voxel of which the damage value is greater than or equal to the limit value after the addition is present in the voxels extracted in step S24. If the result of the determination in step S25 is affirmative, e.g., if a voxel satisfying the predetermined criterion is present in the surface of the voxel object having collided with the collision determination shape, next, the process of step S26 is executed. If, on the other hand, the result of the determination in step S25 is negative, the process in FIG. 25 ends.

In step S26, the processor 81 sets the condition flag to ON and stores voxel data of the voxel determined as satisfying the predetermined criterion as the criterion voxel data. The condition flag is a flag indicating that a voxel satisfying the predetermined criterion is present in the surface of the voxel object having collided with the collision determination shape. This condition flag will be referenced in the voxel data update process to be performed next.

If the process of step S26 is performed, or if the determination is NO in step S22, or if the determination is NO in step S25, the processor 81 ends the process shown in FIG. 25.

### (Voxel Data Update Process)

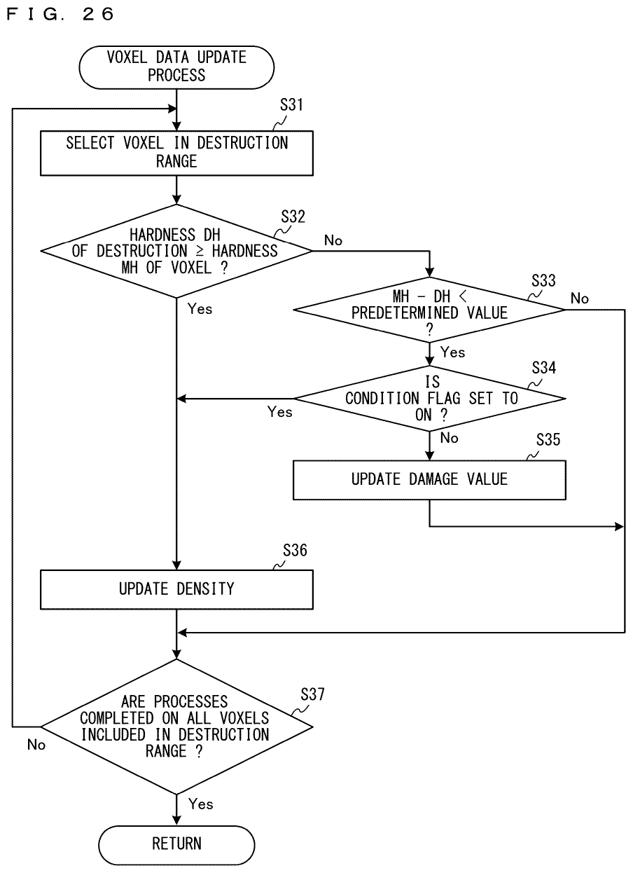

With reference to FIG. 26, the voxel data update process in step S7 is described below. FIG. 26 is a flow chart showing an example of the voxel data update process in step S7.

In step S31, the processor 81 selects a single voxel included in the destruction range set in step S6, among voxels in volume data indicating the voxel object hit by the destruction action. Here, a voxel completely included in the destruction range or a voxel partially included in the destruction range is selected. For example, if the destruction action hits the terrain object 220 defined by voxels in the field voxel space, a single voxel included in the destruction range set in step S6 is selected among the voxels in the field voxel space. After step S31, the process of step S32 is executed.

In step S32, the processor 81 determines whether or not the hardness DH of the destruction action is greater than or equal to the hardness MH of the material indicated by the material data of voxel data. Here, it is determined whether or not the hardness of the destruction action and the hardness of the voxel object satisfy the first condition. That is, it is determined whether or not the destruction action is hard for the voxel object, and the voxel object is destroyed by a single destruction action. If the result of the determination in step S32 is affirmative, next, the process of step S36 is executed. If, on the other hand, the result of the determination in step S32 is negative, next, the process of step S33 is executed.

In step S33, the processor 81 determines whether or not the difference (MH-DH) between the hardness MH of the material of the voxel and the hardness DH of the destruction action is less than the predetermined value. Here, it is determined whether or not the hardness of the destruction action and the hardness of the voxel object satisfy the second condition. That is, it is determined whether or not the voxel selected in step S31 is a voxel to which the damage value can be added by the destruction action. If the result of the determination in step S33 is affirmative, next, the process of step S34 is executed. If, on the other hand, the result of the determination in step S33 is negative, next, the process of step S37 is executed.

In step S34, the processor 81 determines whether or not the condition flag is set to ON in step S26 in the above destruction determination process. That is, it is determined whether or not a voxel satisfying the predetermined criterion regarding the damage value is present in the collision range of the voxel object having collided with the collision determination shape. The voxel satisfying the predetermined criterion is a voxel on which damage can be caused by the current destruction action and of which the damage value is greater than or equal to the limit value after the damage is caused by the current destruction action. If the result of the determination in step S34 is affirmative, next, the process of step S36 is executed. If, on the other hand, the result of the determination in step S34 is negative, next, the process of step S35 is executed.

In step S35, the processor 81 updates the damage value of the voxel. For example, the processor 81 adds 1 to the damage value of the voxel. A value to be added to the damage value may differ based on the hardness of the destruction action and the hardness of the material. If a voxel satisfying the above predetermined criterion is not present in the collision range in the process of step S35, a value is added to the damage value of a voxel in the destruction range without updating the density of the voxel. On the mesh of the voxel after a value is added to the damage value of the voxel, display indicating that damage is caused may be performed. After step S35, the process of step S37 is executed.

In step S36, the processor 81 updates the density of the voxel to a value indicating that the voxel object is not present. For example, if the voxel is completely included in the destruction range (if the voxel is present inside the destruction range), the processor 81 sets the density of the voxel to “0”. If the voxel is partially included in the destruction range (if the voxel is present at the boundary of the destruction range), the processor 81 updates the density of the voxel to, for example, a value less than or equal to the reference value. If the hardness DH of the destruction action is greater than or equal to the hardness MH of the material of the voxel, the determination is YES in step S32, and the process of step S36 is performed. Consequently, the voxel is destroyed by a single destruction action without adding a value to the damage value of the voxel. Also if the determination is YES in step S34, the process of step S36 is performed. Consequently, even in a voxel in which a value is normally added to the damage value of the voxel because the above second condition is satisfied (a voxel in which MH-DH<the predetermined value), if a voxel satisfying the above predetermined criterion is present in the collision range, voxels in the destruction range are destroyed.

In a case where a voxel satisfying the predetermined criterion is present in the collision range, the process of step S36 is executed on a voxel having hardness less than or equal to the hardness of the voxel satisfying the predetermined criterion. For example, in the destruction range relating to the current destruction action, a voxel having a hardness of “3” and a voxel having a hardness of “2” are present, and it is determined that the voxel having a hardness of “3” satisfies the above predetermined criterion. That is, if a value is added to the damage value of the voxel having a hardness of “3” in accordance with the current destruction action, it is determined that the damage value after the addition is greater than or equal to the limit value, and voxel data of the voxel is stored as the criterion voxel data. In this case, the density of another voxel having a hardness of “3” in the destruction range is updated even if the damage value of the other voxel is not greater than or equal to the limit value by the current destruction action. For example, even if the current damage value of another voxel having a hardness of “3” in the destruction range is “0”, the process of step S36 is executed on the other voxel, and the other voxel is destroyed. Regarding a voxel having a hardness of “2” in the destruction range, MH-DH<the predetermined value is satisfied. Thus, the process of step S36 is executed also on the voxel having a hardness of “2” in the destruction range, and the voxel is destroyed. That is, a voxel having hardness smaller than the hardness of a voxel satisfying the predetermined criterion is also destroyed.

If the process of step S36 is performed, or if the process of step S35 is performed, or if the determination is NO in step S33, the processor 81 executes the process of step S37.

In step S37, the processor 81 determines whether or not the processes of the above steps S31 to S36 are completed on all the voxels included in the destruction range among the plurality of voxels in the voxel space relating to the voxel object hit by the destruction action. If the result of the determination in step S37 is affirmative, the process shown in FIG. 26 ends. If, on the other hand, the result of the determination in step S37 is negative, the processor 81 changes a voxel as a target on which the process is to be performed among the voxels in the destruction range, and executes the process of step S31 again.

The processes shown in the above flow charts are merely illustrative, and the order and the contents of the processes, and the like may be appropriately changed.

As described above, in the exemplary embodiment, if at least one voxel satisfying the predetermined criterion regarding the damage value is present in the destruction range set by the current destruction action (step S25: YES), the voxel values of a voxel having the same hardness as or hardness less than the hardness of the voxel satisfying the predetermined criterion in the destruction range are updated to a density indicating that an object is not present. The voxel satisfying the predetermined criterion is a voxel of which the damage value is greater than or equal to the limit value by the current destruction action. If only a voxel of which the damage value is greater than or equal to the limit value by the current destruction action is destroyed, a voxel object after the destruction from has an awkward shape. The above process can prevent such a situation.

In the exemplary embodiment, before a value is actually added to the damage value of a voxel by the current destruction action, it is determined whether or not a voxel satisfying the predetermined criterion by the current destruction action is present. Consequently, even if a value is not actually added to the damage value of a voxel, it is possible to determine whether a voxel satisfying the predetermined criterion is present. Thus, it is possible to reduce the processing load.

In the exemplary embodiment, without determining whether or not a voxel satisfying the predetermined criterion is present regarding all the voxels in the destruction range, it is determined whether or not some of the voxels included in the destruction range (voxels forming the surface of a voxel object) satisfy the predetermined criterion. Consequently, it is possible to reduce the processing load.

### (Variations)

While the exemplary embodiment has been described above, the exemplary embodiment is merely an example and may be modified as follows, for example.

For example, in the above exemplary embodiment, a damage value is set for a voxel, a value is added to the damage value by the destruction action, and if the damage value is greater than or equal to a limit value set in advance, the voxel is destroyed. In another exemplary embodiment, an endurance value may be set for a voxel, the endurance value may be decreased by the destruction action, and if the endurance value is less than or equal to a predetermined value, the voxel may be destroyed. An increase in the damage value by the destruction action and a decrease in the endurance value by the destruction action have the same technical significance. To store the state where damage caused on a voxel increases, the damage value that increases in accordance with the destruction action may be used, or the endurance value that decreases in accordance with the destruction action may be used.

That is, if the destruction action hits a voxel object, the voxel values may be updated to a damage value indicating that damage increases. “The voxel values are updated to a damage value indicating that damage increases” includes increasing the damage value set for the voxel and decreasing the endurance value set for the voxel.

In the above exemplary embodiment, in a case where a voxel is destroyed if the damage value of the voxel is greater than or equal to the limit value, a voxel satisfying the predetermined criterion is a voxel greater than or equal to the limit value set in advance if the damage value of the voxel is increased by the destruction action. In a case where a voxel is destroyed if the endurance value of the voxel is less than or equal to the predetermined value, a voxel satisfying the predetermined criterion is a voxel of which the endurance value is less than or equal to the predetermined value if damage is caused on the voxel by the destruction action. That is, the voxel satisfying the predetermined criterion is a voxel in which damage to the voxel exceeds a damage upper limit set in advance if damage to the voxel increases by the destruction action. Here, “damage to the voxel exceeds the damage upper limit” includes the state where the damage value of the voxel is greater than or equal to the limit value, and the state where the endurance value of the voxel is less than or equal to the predetermined value.

In the above exemplary embodiment, before the damage values of voxels in the destruction range are actually updated, it is determined whether or not a voxel satisfying the predetermined criterion regarding the damage value is present regarding some of the voxels included in the destruction range. In another exemplary embodiment, a similar process may be performed on all the voxels in the destruction range. That is, it may be determined whether or not a voxel satisfying the predetermined criterion is present regarding all the voxels in the destruction range. If the damage values of voxels in the destruction range are actually updated, and a voxel of which the damage value is greater than or equal to the limit value after the update is present, the voxels in the destruction range may be destroyed.

In the above exemplary embodiment, if the destruction action hits a voxel object, and at least one voxel satisfying the predetermined criterion regarding the damage value is present, the densities of voxels in the destruction range are updated. In another exemplary embodiment, if a predetermined number of voxels satisfying the predetermined criterion regarding the damage value are present, the densities of voxels in the destruction range may be updated.

In the above exemplary embodiment, based on the relationship between the hardness of the destruction action and the hardness of the material of a voxel, it is determined whether to destroy a voxel object or cause damage on the voxel object if the destruction action hits the voxel object. In another exemplary embodiment, based only on the hardness of the material of a voxel on the destruction target side, it may be determined whether to destroy a voxel object or cause damage on the voxel object if the destruction action hits the voxel object.

In the above exemplary embodiment, in a case where the destruction action hits a voxel object, and if a voxel satisfying the predetermined criterion is present, the process of updating the density of a voxel having hardness less than or equal to the “hardness” of the voxel satisfying the predetermined criterion is performed. In another exemplary embodiment, if a voxel satisfying the predetermined criterion is present, the process of updating the density of a voxel having hardness less than or equal to predetermined hardness may be performed. The above process may be performed based not only on the “hardness” of the material but also on the material quality of the material. For example, if a voxel satisfying the predetermined criterion is present, the process of updating the density of a voxel having a predetermined kind of material may be performed. For example, there may be a plurality of material qualities for a material, and the relationships between the material qualities may be set in advance. If a voxel satisfying the predetermined criterion is present, the process of updating the density of a voxel having a kind of material having a predetermined relationship with the kind of material of the voxel satisfying the predetermined criterion may be performed.

In the above exemplary embodiment, a case has been described where the destruction action is performed on a terrain object on which the player character can move. Also in a case where the destruction action hits a voxel object other than the terrain object, a process similar to the above is performed. That is, in a case where the destruction action hits the voxel object, and if a voxel satisfying the predetermined criterion regarding the damage value is present, the densities of voxels in the destruction range are updated. If, on the other hand, a voxel satisfying the predetermined criterion is not present, values are added to the damage values of the voxels in the destruction range.

In the above exemplary embodiment, the density of a voxel in the destruction range is set to “0”, thereby setting a value indicating that an object is not present in the voxel. Consequently, a portion in the destruction range in a voxel object is erased, and the voxel object is destroyed. The destruction (erasure) of the voxel object may be set not only by setting the density of voxel data to “0”, but also by setting the density to another value. For example, regarding the density, “a value indicating that an object is not present” may not be limited to “0”, and may be any value less than the reference value (e.g., 128). Regarding the density, “a value indicating that an object is present” may be a value in the range from 1 to 255, or may be a value greater than or equal to the reference value. The destruction of a voxel object may be performed not only by changing the density of voxel data, but also by another method. For example, a flag indicating the presence or absence of an object may be stored in voxel data, and if the flag is set to ON, it may be indicated that an object is present in the voxel. If the flag is set to OFF, it may be indicated that an object is not present in the voxel (e.g., a cavity).

The above processes may be executed not only by the game system 1 but also by any other information processing apparatus or information processing system. The information processing system may include a plurality of apparatuses, and the plurality of apparatuses may be connected together via a network (e.g., a LAN, the Internet, or the like).

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors of an information processing apparatus to execute image processing comprising:
storing, in a memory, volume data indicating a virtual object in a virtual space, and with respect to each voxel included in a voxel space placed in the virtual space, holding voxel values at least including a density indicating a degree to which an object occupies inside of a space defined by the voxel, and a damage value indicating damage caused on the voxel;
based on an operation input of a player, moving a player character in the virtual space;
based on an operation input of the player, causing the player character to perform a destruction action;
in a case where the destruction action hits the virtual object,
if a voxel satisfying a predetermined criterion is present at least regarding the damage value, updating the voxel values of a voxel included in an erasure range set based on a position of the player character to a density indicating that the virtual object is not present, and
if a voxel satisfying the predetermined criterion is not present, updating the voxel values of the voxel included in the erasure range to a damage value indicating that damage increases; and
based on the volume data, at least drawing a polygon mesh representing a surface of the virtual object, thereby generating an image of the virtual space.

2. The one or more non-transitory computer-readable media according to claim 1, wherein
the voxel satisfying the predetermined criterion is a voxel in which the damage exceeds a damage upper limit set in advance in a case where the damage is increased by the destruction action.

3. The one or more non-transitory computer-readable media according to claim 1, wherein
the image processing further comprises, if the destruction action is performed, determining a hit position where the destruction action hits the virtual object, and
the voxel satisfying the predetermined criterion is a voxel that is included in a predetermined range including the hit position and has a predetermined damage value.

4. The one or more non-transitory computer-readable media according to claim 3, wherein
the image processing further comprises making a contact determination between the polygon mesh or a determination polygon mesh representing the surface of the virtual object generated for a determination and a determination shape set based on the destruction action, thereby determining the hit position.

5. The one or more non-transitory computer-readable media according to claim 1, wherein
the voxel values further include data indicating hardness or a kind of material of the voxel, and
the image processing further comprises
in a case where the destruction action hits the virtual object, and if the voxel satisfying the predetermined criterion is present, updating the voxel value of a voxel having hardness less than or equal to predetermined hardness or a predetermined kind of material to a density indicating that the virtual object is not present.

6. The one or more non-transitory computer-readable media according to claim 1, wherein
the erasure range is a sphere, an ellipsoid, or a shape obtained by asymmetrically deforming an ellipsoid.

7. The one or more non-transitory computer-readable media according to claim 1, wherein
the virtual object is a terrain in the virtual space.

8. The one or more non-transitory computer-readable media according to claim 1, wherein
the image processing further comprises
based on the density, generating the polygon mesh by an algorithm for placing a polygon so that vertex positions are determined between a voxel defined as being inside the virtual object and a voxel defined as being outside the virtual object, and
if the destruction action is performed, recalculating vertices of the polygon mesh in a range including a voxel of which at least the voxel values are updated.

9. An information processing system comprising: one or more processors that are configured to execute image processing comprising:
storing, in a memory, volume data indicating a virtual object in a virtual space, and with respect to each voxel included in a voxel space placed in the virtual space, holding voxel values at least including a density indicating a degree to which an object occupies inside of a space defined by the voxel, and a damage value indicating damage caused on the voxel;
based on an operation input of a player, moving a player character in the virtual space;
based on an operation input of the player, causing the player character to perform a destruction action;
in a case where the destruction action hits the virtual object,
if a voxel satisfying a predetermined criterion is present at least regarding the damage value, updating the voxel values of a voxel included in an erasure range set based on a position of the player character to a density indicating that the virtual object is not present, and
if a voxel satisfying the predetermined criterion is not present, updating the voxel values of the voxel included in the erasure range to a damage value indicating that damage increases; and
based on the volume data, at least drawing a polygon mesh representing a surface of the virtual object, thereby generating an image of the virtual space.

10. The information processing system according to claim 9, wherein
the voxel satisfying the predetermined criterion is a voxel in which the damage exceeds a damage upper limit set in advance in a case where the damage is increased by the destruction action.

11. The information processing system according to claim 9, wherein
the image processing further comprises, if the destruction action is performed, determining a hit position where the destruction action hits the virtual object, and
the voxel satisfying the predetermined criterion is a voxel that is included in a predetermined range including the hit position and has a predetermined damage value.

12. The information processing system according to claim 11, wherein
the image processing further comprises making a contact determination between the polygon mesh or a determination polygon mesh representing the surface of the virtual object generated for a determination and a determination shape set based on the destruction action, thereby determining the hit position.

13. The information processing system according to claim 9, wherein
the voxel values further include data indicating hardness or a kind of material of the voxel, and
the image processing further comprises
in a case where the destruction action hits the virtual object, and if a voxel satisfying the predetermined criterion is present, updating the voxel value of a voxel having hardness less than or equal to predetermined hardness or a predetermined kind of material to a density indicating that the virtual object is not present.

14. The information processing system according to claim 9, wherein
the erasure range is a sphere, an ellipsoid, or a shape obtained by asymmetrically deforming an ellipsoid.

15. The information processing system according to claim 9, wherein
the virtual object is a terrain in the virtual space.

16. The information processing system according to claim 9, wherein
the image processing further comprises
based on the density, generating the polygon mesh by an algorithm for placing a polygon so that vertex positions are determined between a voxel defined as being inside the virtual object and a voxel defined as being outside the virtual object, and
if the destruction action is performed, recalculating vertices of the polygon mesh in a range including a voxel of which at least the voxel values are updated.

17. An information processing apparatus comprising: one or more processors that are configured to execute image processing comprising:
storing, in a memory, volume data indicating a virtual object in a virtual space, and with respect to each voxel included in a voxel space placed in the virtual space, holding voxel values at least including a density indicating a degree to which an object occupies inside of a space defined by the voxel, and a damage value indicating damage caused on the voxel;
based on an operation input of a player, moving a player character in the virtual space;
based on an operation input of the player, causing the player character to perform a destruction action;
in a case where the destruction action hits the virtual object,
if a voxel satisfying a predetermined criterion is present at least regarding the damage value, updating the voxel values of a voxel included in an erasure range set based on a position of the player character to a density indicating that the virtual object is not present, and
if a voxel satisfying the predetermined criterion is not present, updating the voxel values of the voxel included in the erasure range to a damage value indicating that damage increases; and
based on the volume data, at least drawing a polygon mesh representing a surface of the virtual object, thereby generating an image of the virtual space.

18. The information processing apparatus according to claim 17, wherein
the voxel satisfying the predetermined criterion is a voxel in which the damage exceeds a damage upper limit set in advance in a case where the damage is increased by the destruction action.

19. The information processing apparatus according to claim 17, wherein
the image processing further comprises, if the destruction action is performed, determining a hit position where the destruction action hits the virtual object, and
the voxel satisfying the predetermined criterion is a voxel that is included in a predetermined range including the hit position and has a predetermined damage value.

20. An information processing method performed by an information processing system, wherein
in the information processing system, volume data indicating a virtual object in a virtual space, and with respect to each voxel included in a voxel space placed in the virtual space, holding voxel values at least including a density indicating a degree to which an object occupies inside of a space defined by the voxel, and a damage value indicating damage caused on the voxel is stored,
the information processing method comprising:
based on an operation input of a player, moving a player character in the virtual space;
based on an operation input of the player, causing the player character to perform a destruction action;
in a case where the destruction action hits the virtual object,
if a voxel satisfying a predetermined criterion is present at least regarding the damage value, updating the voxel values of a voxel included in an erasure range set based on a position of the player character to a density indicating that the virtual object is not present, and
if a voxel satisfying the predetermined criterion is not present, updating the voxel values of the voxel included in the erasure range to a damage value indicating that damage increases; and
based on the volume data, at least drawing a polygon mesh representing a surface of the virtual object, thereby generating an image of the virtual space.

21. The information processing method according to claim 20, wherein
the voxel satisfying the predetermined criterion is a voxel in which the damage exceeds a damage upper limit set in advance in a case where the damage is increased by the destruction action.

22. The information processing method according to claim 20, further comprising, if the destruction action is performed, determining a hit position where the destruction action hits the virtual object, wherein
the voxel satisfying the predetermined criterion is a voxel that is included in a predetermined range including the hit position and has a predetermined damage value.
